(19) United States
(12) Patent Application Publication
(10) Pub. No.: US 2003/0017077 A1
(43) Pub. Date: Jan. 23, 2003

(54) Sample clean-up apparatus for mass spectrometry

(75) Inventors: Jong Hoon Hahn, Pohang-city (KR); Young Chan Kim, Daejeon (KR); Kyung Won Ro, Pohang-city (KR); Nokyoung Park, Pohang-city (KR)

Correspondence Address: LEYDIG VOIT & MAYER, LTD, 700 THIRTEENTH ST. NW, SUITE 300, WASHINGTON, DC, 20005-3960, US

(73) Assignee: Pohang University of Science and Technology Foundation, Pohang-city (KR)

(21) Appl. No.: 10/195,513

(22) Filed: Jul. 16, 2002

(30) Foreign Application Priority Data
Jul. 18, 2001 (KR) 2001-43107

(51) Int. Cl. G01N 35/08

(52) U.S. Cl. 422/81; 422/82; 422/100; 422/101; 436/52; 436/53; 436/173; 436/175; 436/177; 436/178; 436/180; 435/287.3

(57) ABSTRACT

Provided is a sample clean-up apparatus for removing low-molecular weight substances such as salts from high-molecular weight biological samples such as proteins by simple molecular diffusion in a laminar flow channel and enabling solvent exchange for samples to be suitable for mass spectrometry. The sample clean-up apparatus for mass spectrometry includes: a sample inlet through which a mixture sample of interest to be cleaned-up is introduced; clean-up solution inlets through which a clean-up solution is introduced; a channel formed in a substrate with branches connected to the sample inlet and the clean-up solution inlets, the channel allowing flow of laminar streams of the mixture sample and the clean-up solution injected through the sample inlet and the clean-up solution inlet, respectively; low-molecular weight substance outlets connected to opposing branches of the respective clean-up solution inlets, for discharging a low-molecular weight substances of the mixture sample by diffusion into the clean-up solution in the channel; and a high-molecular weight substance outlet connected to an opposing branch of the sample inlet, for discharging a purified high-molecular weight substances of the mixture sample flowing along the channel. The sample clean-up apparatus can remove low-molecular weight substances including salts from high-molecular weight biological samples through simple molecular diffusion in laminar flow with high-speed and high-efficiency, without any separation tools such as a separation membrane or an adsorbing material. The clean-up by the sample clean-up apparatus is advantageously simple with high separation efficiency.

### BACKGROUND OF THE INVENTION

1. Field of the Invention

The present invention relates to a sample clean-up apparatus for mass spectrometry, and more particularly, to a sample clean-up apparatus for removing low-molecular weight substances such as metal ions, salts, and surfactants from high-molecular weight biological samples including enzymes, proteins, peptides, deoxyribonucleic acids (DNAs), and oligonucleotides by molecular diffusion in laminar flow in a microchannel on a substrate and enabling solvent exchange for samples to be suitable for mass spectrometry.

2. Description of the Related Art

For accurate mass spectrometry in the biological science field for high-molecular weight biological samples such as enzymes, proteins, peptides, DNAs, and oligonucleotides, low-molecular weight foreign substances such as metal ions, salts, and surfactants should be removed from the biological samples prior to analysis. Typical methods for purification of high-molecular weight biological samples include dialysis membrane, column chromatography, and solid-phase extraction.

In the conventional purification and separation methods, the dialysis method using a dialysis membrane is time consuming and is difficult to automate. In addition, clogging of micropores of the membrane used for dialysis induces low purification efficiency, and thus the membrane cannot be reused. Column chromatography uses expensive packing materials and high-pressure pumps and needs considerable time for separation.

Also, in association with the clean-up of samples for such molecular purification and separation methods, there is also a problem of sample loss or deterioration during sample transfer to another operating unit. This problem in sample clean-up is more serious in the biological science field where high-throughput sample processing is needed.

### SUMMARY OF THE INVENTION

To solve the above drawbacks, it is an object of the present invention to provide a sample clean-up apparatus for removing low-molecular weight substances such as metal ions, salts, and surfactants from high-molecular weight biological samples such as enzymes, proteins, peptides, deoxyribonucleic acids (DNAs), and oligonucleotides by simple molecular diffusion in laminar flow in a microchannel and enabling solvent exchange for samples to be suitable for mass spectrometry, without any separation tool such as a separation membrane or an adsorbing material.

It is another object of the present invention to provide an economic, easy-to-manufacture sample clean-up apparatus for mass spectrometry in which a channel is fabricated in a glass, quartz, fused silica, or plastic substrate based on the “lab-on-a-chip” technology and by which high-molecular weight biological substances are purified by molecular diffusion in laminar streams along the channel.

It is a still another object of the present invention to provide a sample clean-up apparatus for mass spectrometry in which molecular purification and separation can be performed repeatedly at high rate and thus automated mass spectrometry is ensured.

To achieve the objects of the present invention, there is provided a sample clean-up apparatus for mass spectrometry, which removes impurities such as salts from high-molecular substances such as protein samples prior to mass analysis, comprising: a sample inlet through which a mixture sample to be cleaned-up is introduced; clean-up solution inlets through which a clean-up solution is introduced; a channel formed in a substrate with branches connected to the sample inlet and the clean-up solution inlets, the channel allowing flow of laminar streams of the mixture sample and the clean-up solution introduced through the sample inlet and the clean-up solution inlet, respectively; low-molecular weight substance outlets connected to opposing branches of the respective clean-up solution inlets, for discharging a low-molecular weight substances of the mixture sample by diffusion into the clean-up solution in the channel; and a high-molecular weight substance outlet connected to an opposing branch of the sample inlet, for discharging a high-molecular weight substances of the mixture sample flowing along the channel.

To form a laminar stream of the mixture sample in the middle of the channel and laminar streams of the clean-up solution around the laminar stream of the clean-up sample, it is preferable that the sample inlet and the high-molecular weight substance outlet are aligned to the longitudinal axis of the channel, the clean-up solution inlets are located close to both sides of the sample inlet, and the low-molecular substance outlets are located close to both sides of the high-molecular substance outlet.

It is preferable that the substrate with the channel is constructed as a lab-on-a-chip.

It is preferable that the mixture sample includes substances having a molecular weight difference no less than 100.

It is preferable that the mixture sample comprises a low-molecular weight substances selected from the group consisting of salts, metal ions, and surfactants and a high-molecular weight substances selected from the group consisting of proteins, peptides, enzymes, deoxyribonucleic acids (DNAs), and oligonucleotides, the low-molecular weight substances discharged through the low-molecular weight outlets comprises salts, metal ions, and surfactants, and the high-molecular weight substances discharged through the high-molecular weight substance outlet comprises proteins, peptides, enzymes, deoxyribonucleic acids (DNAs), and oligonucleotides and is analyzed by the mass spectrometer connected to the high-molecular weight substance outlet.

In the sample clean-up apparatus according to the present invention, solvent exchange of the mixture sample may occur while the laminar streams flow along the channel.

### BRIEF DESCRIPTION OF THE DRAWINGS

The above objects and advantages of the present invention will become more apparent by describing in detail preferred embodiments thereof with reference to the attached drawings in which:

FIG. 1 shows the principle of a sample clean-up method based on molecular diffusion in a laminar flow channel;

FIG. 2 shows a sample clean-up apparatus for mass spectrometry according to the present invention;

FIG. 3 is a sectional view of a preferred embodiment of the sample clean-up apparatus (chip) for protein separation according to the present invention;

FIG. 4 shows a system setup for clean-up using the sample clean-up chip of FIG. 3;

FIG. 5 is a sectional view of another preferred embodiment of the sample clean-up chip for use in connection with a mass spectrometer according to the present invention;

FIG. 6 shows a system setup of an automatic analysis system for mass spectrometry directly connected with the sample clean-up chip of FIG. 5;

FIGS. 7A and 7B show the mass spectrum illustrating the molecular separation and purification efficiency of a sample clean-up chip according to the present invention;

FIGS. 8A and 8B show the mass spectrum illustrating the molecular separation and purification efficiency of a sample clean-up chip used in connection with a mass spectrometer according to the present invention; and

FIGS. 9A through 9D comparatively show the efficiency between a common clean-up method using a dialysis membrane and the clean-up method using the sample clean-up chip according to the present invention.

### DETAILED DESCRIPTION OF THE INVENTION

Preferred embodiments of the present invention will be described more fully with reference to the appended drawings. Description of the prior art or an unnecessary structure of the present invention that makes the subject matter of the present invention obscure will be omitted. The terms used in the following description are defined on a functional basis, and thus it will be appreciated by those skilled in the art that the terms may be appropriately changed based on users' or operators' intentions and practices without departing from the meaning intended in the following description.

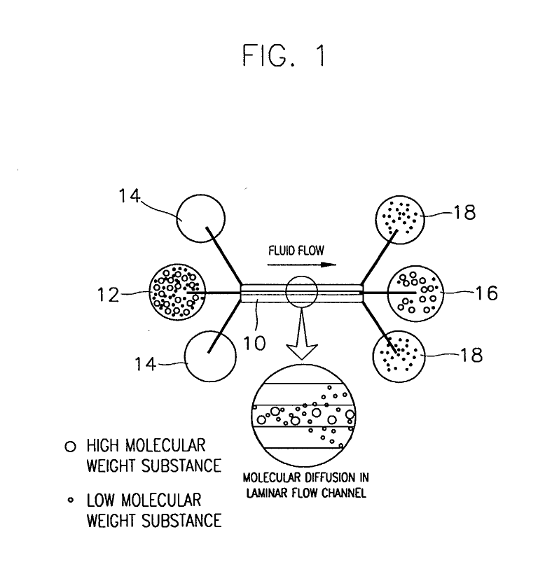

FIG. 1 illustrates the principle of a sample clean-up method based on molecular diffusion in a laminar flow channel.

A channel having a width and depth of tens to hundreds of micrometers has a very low Reynolds number for fluid flow therein. A fluid at a low Reynolds number forms a very stable laminar flow. Two or more layered laminar streams do not mix without a physical barrier except for the diffusion of molecules. Diffusion-based molecular separation depends on the particle size, i.e., the molecular weight of substances. Low-molecular weight substances such as salts have a high diffusion rate and a long migration length, whereas high-molecular weight materials such as proteins have a low diffusion rate and a short migration length. For example, it takes 0.2 seconds for a small molecule having a molecular weight of 300 to migrate 10 μm and 200 times longer for a macromolecule having a diameter of 0.5 μm to migrate the same distance.

In FIG. 1, the principle of purification and separation of materials having different molecular weights by molecular diffusion in a laminar flow channel without using a physical barrier such as a separation membrane is illustrated. Referring to FIG. 1, as different kinds of fluid are pumped into three inlets 12 and 14 shown on the left, the fluids merges in a channel 10 at the chip center and laminar streams that do not mix are formed.

The sample clean-up apparatus shown in FIG. 1 is for purification, high-molecular weight substances by removing low molecular weight substances. A sample solution, which is a mixture solution, is introduced into a sample inlet 12, and a clean-up solution such as water or buffer solution is introduced into clean-up solution inlets 14 at both sides of the sample inlet 12. The three fluids flow laminarly in the channel 10 at the chip center. Because high-molecular weight substances have relatively low diffusion rates than low-molecular weight substances, high-molecular weight substances introduced through the sample inlet 12 migrate and reach a sample outlet 16, whereas low-molecular weight substances are diffused out and discharged through clean-up solution outlets 18. Finally, purified, high-molecular weight substances are obtained in the sample outlet 16. Here, the composition of the sample solution flowing through the core of the channel can be changed through solvent exchange with the clean-up solution flowing around the sample solution in the channel by adjusting the flow rate of each solution.

In designating the constituent elements of the sample clean-up apparatus according to the present invention, the sample outlet 16 and the clean-up solution outlets 18 may be called “high-molecular weight substance outlet” and “low-molecular weight substance outlets”, respectively. Here, the sample outlet 16 is an outlet through which a mixture sample injected through the sample inlet 12, which is to be separated, is discharged, and the “clean-up solution outlet” 18 is an outlet through which the clean-up solution injected through the clean-up solution inlets 18 is discharged. Because high-molecular weight substances are discharged through the sample outlet 16, the sample outlet 16 may be referred to as “high-molecular weight substance outlet”. Similarly, because low-molecular weight substances separated from the mixture sample solution are discharged through the clean-up solution outlets 18, the clean-up solution outlets 18 may be referred to as “low-molecular weight substance outlets”.

High-molecular weight substances include proteins, peptides, enzymes, deoxyribonucleic acids (DNAs), and oligonucleiotides. Low-molecular weight substances include salts, metal ions, and surfactants. For convenience of explanation, protein will be referred to as a typical example of high-molecular weight substances and salt as a typical example of low-molecular weight substances.

According to the present invention, a sample clean-up apparatus for use in the purification and separation of a sample is manufactured as a “lab-on-a-chip” based on the principle described above so that low-molecular weight salts can be removed rapidly from a high-molecular weight protein sample with high efficiency.

In general, expensive analytical instruments such as liquid chromatograph, capillary electrophoresis, nuclear magnetic resonance (NMR), and mass spectrometers are used for the analysis of the structure or composition of protein. However, a protein sample solution commonly includes a large amount of metal ions, salts, and surfactants, which limit accurate sample analysis by forming adducts or clusters and reduce detection sensitivity. The presence of impurities such as salts makes mass spectrometry and itself impossible. Therefore, a sample clean-up process for desalting is necessary prior to analysis using such analytical instruments. A solvent used for mass spectrometry differs from a solvent used to extract protein in the preparation of a sample solution, and thus the solvent of the sample solution needs to be changed for mass spectrometry. According to the present invention, the sample clean-up apparatus for mass spectrometry is formed as a “lab-on-a-chip” and ensures high-speed, automated clean-up of biological samples by removing low-molecular weight substances such as salts from, for example, a protein sample solution and changing the solvent composition of the sample solution.

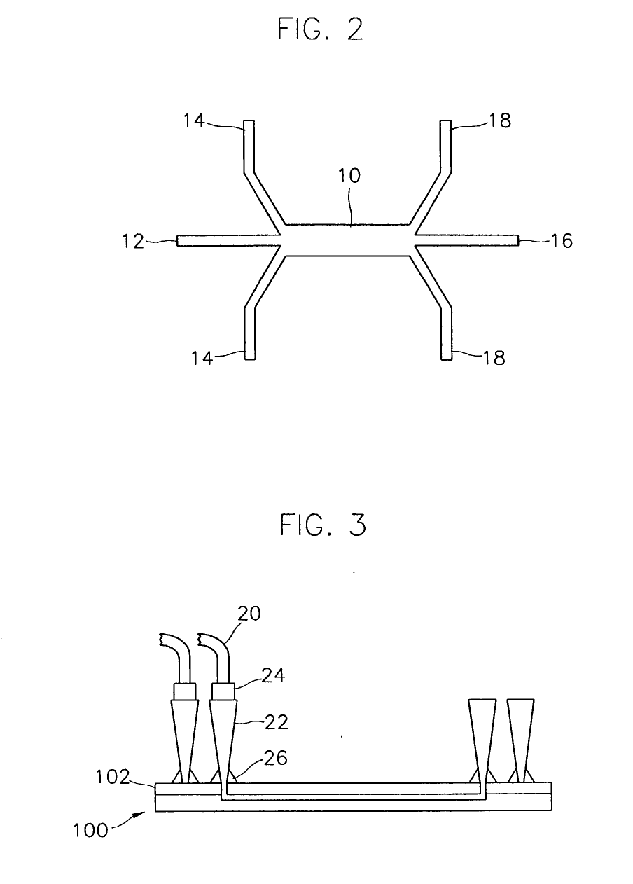

FIG. 2 illustrates a sample clean-up apparatus for mass spectrometry according to the present invention, which is manufactured as a lab-on-a-chip for molecular purification by laminar flow. A sample inlet 12 has a width of 0.01 μm-10 cm, and a sample solution containing protein of interest that is to be separated and salts is pumped into the chip through the sample inlet 12. Also, a clean-up solution suitable for molecular separation is introduced at a constant rate into the chip through clean-up solution inlets 14, each having a similar width as the sample inlet 12. In a channel 10 having a width of 0.01 μm-30 cm and a length of 0.01 μm-100 cm, the sample solution and the clean-up solutions form laminar streams that do not mix. The middle stream in laminar streams flows at a constant rate and reaches the sample outlet or high-molecular weight substance outlet 16. Here, low-molecular weight salts contained in the sample solution diffused out from the middle stream by rapid diffusion. In contrast, high-molecular weight proteins contained in the sample solution mostly migrate along the middle stream without diffusion. As a result, a desalted protein solution is selectively collected in the high-molecular weight substance outlet 16. As low molecular weight salts diffused out from the middle stream are collected in the clean-up solution outlets 18 with the exchange of solvents. The widths of outlet channels vary depending on the degree of purification of the sample being separated. For obtaining more purified sample, the channel width for the high-molecular weight substance outlet 16 is reduced. The height of the channel can be adjusted within the range of 0.01 μm-10 cm.

For the sample clean-up apparatus according to the present invention, a variety of substrates, such as glass, quartz, fused silica, or plastics, which can be easily processed, are used for the fabrication of the channel. Suitable plastics include polydimethylsiloxane (PDMS), polymethylmethacrylate (PMMA), polycarbonate (PC), polyethylene (PE), polypropylene (PP), and polystyrene (PS). Desired channels are fabricated on a glass, quartz, or fused silica substrate mostly by photolithography and chemical etching techniques, but alternatively can be fabricated by molding, coining, mechanical machining, or laser machining techniques. A channel on a plastic substrate is formed by molding, coining, mechanical machining, or laser machining technique. In particular, in forming a channel in a plastic substrate, a molding technique using a template shaping a molten plastic by hardening, a hot embossing technique in which a planar substrate is hot pressed with a template, or other processing techniques using a mechanical tool or a light or heat source can be applied. The substrate with the channel is assembled together with another substrate so that a complete sample clean-up chip is obtained.

In a preferred embodiment of the present invention, the substrate with a channel is formed of PDMS by molding. A desired positive pattern is formed on a silicon wafer using a negative photoresist, SU-8. Next, PDMS, a silicon-based polymer, is poured on the positive pattern on the silicon wafer and peeled off from the silicon wafer after cross-linking, resulting in a chip with a negative pattern. The resultant PDMS chip is subjected to surface treatment through plasma discharge using a Tesla coil and then combined with a slide glass, which has undergone a cleaning process.

FIG. 3 is a sectional view of a sample clean-up chip for protein separation according to the present invention. A PDMS chip 100 having a negative pattern, as described with reference to FIG. 2, and a slide glass 102 with holes for reservoirs are bonded, and 200-μL pipette tips 22 used as the reservoirs are cut to an appropriate size and fitted into the holes. The reservoirs are fixed to the slide glass 102 using epoxy 26. Gas-tight syringes (not shown) containing the sample and clean-up solutions are connected to the PDMS chip 100 via the reservoirs by Teflon tubes 20. Here, an elastic tygon tubing 24 cut to an appropriate size is fitted around one end of each of the Teflon tubes 20 to ensure good tightening with the reservoirs of the PDMS chip 100.

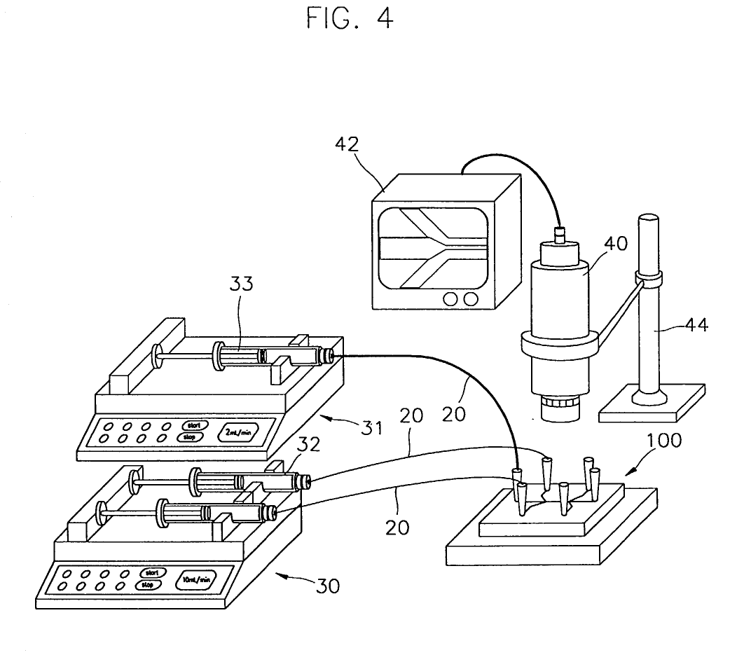

FIG. 4 illustrates a system setup for clean-up using the sample clean-up chip according to the present invention. Referring to FIG. 4, sample and clean-up solutions contained in a 500-μL gas-tight syringe 33 and a 5-μL gas-tight syringe 32, respectively, are introduced into the chip 100 at constant flow rates by syringe pumps 31 and 30, respectively, to form laminar streams in the chip 100. In the present embodiment, the sample solution containing protein to be purified is introduced into the chip 100 through the Teflon tube 20 at a flow rate of 2 μL/min and the clean-up solution at a flow rate of 12 μL/min. Here, bubbles hinder formation of laminar streams in the channel such that a target molecule to be purified will not get discharged through the sample outlet. To prevent this problem, the flow of fluid is monitored by a color charge-coupled device (CCD) camera 40 connected to a support 44. When bubbles in the fluid flow are observed through a monitor 42, the bubbles are removed by increasing the flow rate of the fluid using the syringe pumps 31 and 30.

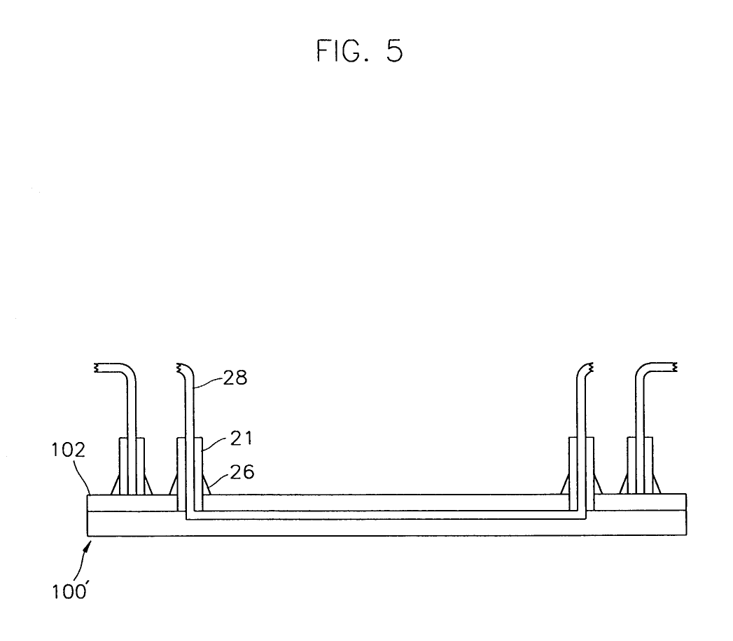

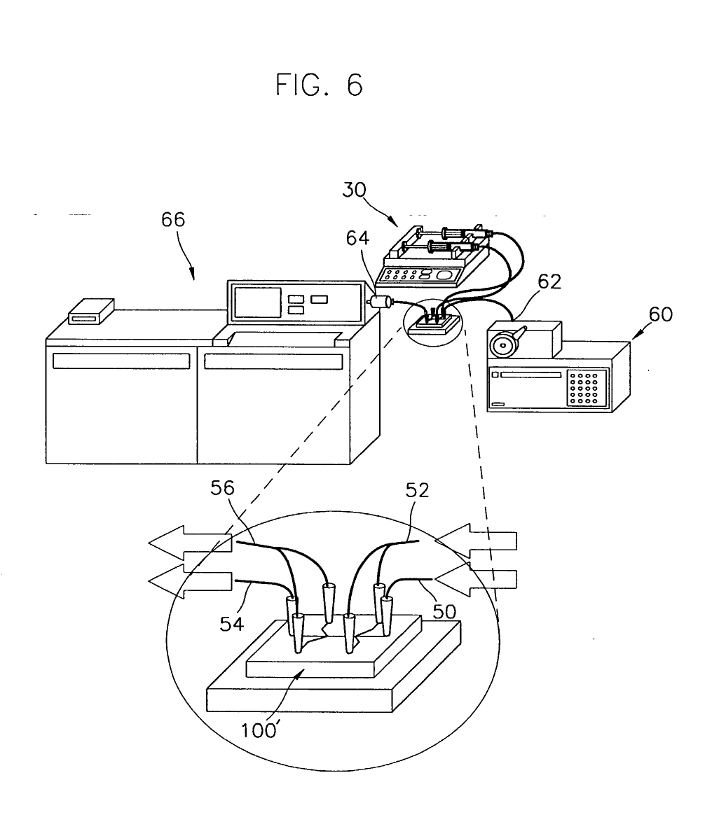

FIG. 5 is a sectional view of another sample clean-up chip according to the present invention for use in connection with a mass spectrometer. Referring to FIG. 5, a sample clean-up chip 100′ is connected to a mass spectrometer 66 (see FIG. 6) by a capillary tube 28. In the present embodiment, an electrospray ionization-mass spectrometer (ESI-MS) is used as the mass spectrometer 66.

The sample clean-up chip 100′ for use in connection with an analytical instrument such as a mass spectrometer is manufactured by a different method from the method for the chip 100 illustrated with reference to FIG. 3. The formation of the sample inlet 12 and the sample outlet 16 for the sample clean-up chip 100′ will be described below. When the pipette tips 22 having a large volume, as described with reference to FIG. 3, are used as the sample inlet 12 and the sample outlet 16 for the sample clean-up chip 100′, sample loss is considerable. To prevent such large sample loss, capillaries 28 are used for the sample inlet 12 and the sample outlet 16, instead of the pipette tips 22 shown in FIG. 3. The locations of the sample inlet 12 and the sample outlet 16 are marked on a cover glass 102 and drilled to form reservoir holes having a diameter of 2 mm each. After aligning the holes in the cover glass 102 with the channels of the sample clean-up chip 100′, the cover glass 120 and the sample clean-up chip 100′ are bonded with each other after surface treatment by corona discharge. A Teflon tube 21 cut to a length of about 1 cm is prepared. The capillary 28 having an outer diameter slightly greater than that of the Teflon tube 21 and an inner diameter corresponding to the width of the channel is fit into the Teflon tube 21 such that their ends align. The Teflon tube 21 with the capillary 28 is inserted into a corresponding channel of the sample clean-up chip 100′ through a through hole of the cover glass 102 to form the sample inlet 12 (or the sample outlet 16), and then it is checked using a microscope whether the inner diameter of the capillary tube 28 is well aligned with the channel of the sample clean-up chip 100′. Next, the Teflon tube 21 is fixed to the cover glass 102 using epoxy 26. clean-up solution inlets and outlets for the sample clean-up chip 100′ are formed in the same manner as described with reference to FIG. 3.

FIG. 6 shows a system setup of an automatic analytical system in which the sample clean-up chip 100′ of FIG. 5 is connected to the mass spectrometer 66. A capillary tube 50 connected to the sample inlet of the sample clean-up chip 100′ is connected to an outlet of a rheodyne valve 62. The clean-up solution inlets of the sample clean-up chip 100′ are connected to corresponding syringe pumps 30 using tygon tubes (not shown) and Teflon tubes 52 in the same manner as illustrated in FIG. 4. A capillary 54 connected to the sample outlet of the sample clean-up chip 100′ is connected to and aligned with a capillary of a probe 64 of an ESI-MS used as the mass spectrometer 66. clean-up solution outlets of the sample clean-up chip 100′ are guided to an exterior bottle using tygon tubes (not shown) and Teflon tubes 56, like the clean-up solution inlets. Before connection of the capillary 50 connected to the sample inlet to the probe 64 of the ESI-MS, the interior of the sample clean-up chip 100′ is monitored for a sufficient time period while flowing clean-up solutions to prevent incorporation of bubbles into the channel of the sample clean-up chip 100′. When all systems are set up, sample and clean-up solutions are introduced by syringe pumps 30 and a HPLC (High Performance Liquid Chromatography) pump 60. 0.5-μL of the sample solution is injected into the rheodyne valve 62, and the sample and clean-up solutions are introduced at a flow rate of 2 μL/min and 12 μL/min, respectively.

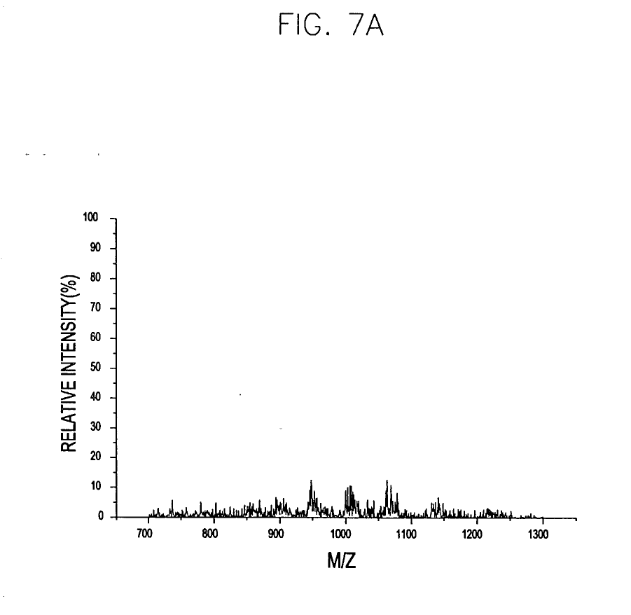

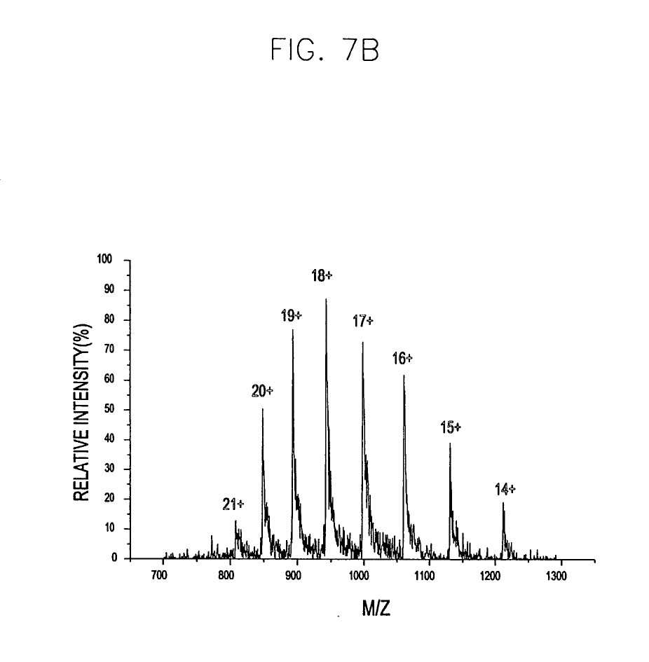

FIGS. 7A and 7B show the mass spectra of a protein sample to illustrate the desalting efficiency in a sample clean-up chip according to the present invention. To determine the desalting efficiency of the protein sample using the sample clean-up chip according to the present invention, the mass spectra of 1 mg/mL of horse heart myogloblin was obtained by a mass spectrometer (ESI-MS) before and after clean-up using the sample clean-up chip. FIGS. 7A and 7B show the mass spectra of the horse heart myoglobin before and after clean-up, respectively. In the present embodiment, a sample clean-up chip, which is not connected to the mass spectrometer, as shown in FIG. 4, was used for sample clean-up.

When a myoglobin sample dissolved in 100 mM of Tris (tri(hydroxymethyl)aminomethane) and 10 mM of EDTA (ethylenediaminetetraacetic acid) with an addition of 500 mM of sodium chloride is directly injected into the ESI-MS, no obvious peaks for myoglobin was obtained, as shown in FIG. 7A. This is because impurities including salts such as high-concentration sodium chloride form adducts and markedly reduce the signal-to-noise ratio so that signals for myoglobin cannot be obtained.

FIG. 7B shows the mass spectra of the horse heart myogloblin by the ESI-MS after clean-up in an off-line mode for about 10 minutes using 10 mM of ammonium acetate with 1% acetic acid as a clean-up solution. As shown in FIG. 7B, the mass spectra showed improved sensitivity to myoglobin. It is evident that low molecular weight salts contained in the myoglobin sample solution are removed by diffusion to the clean-up solution.

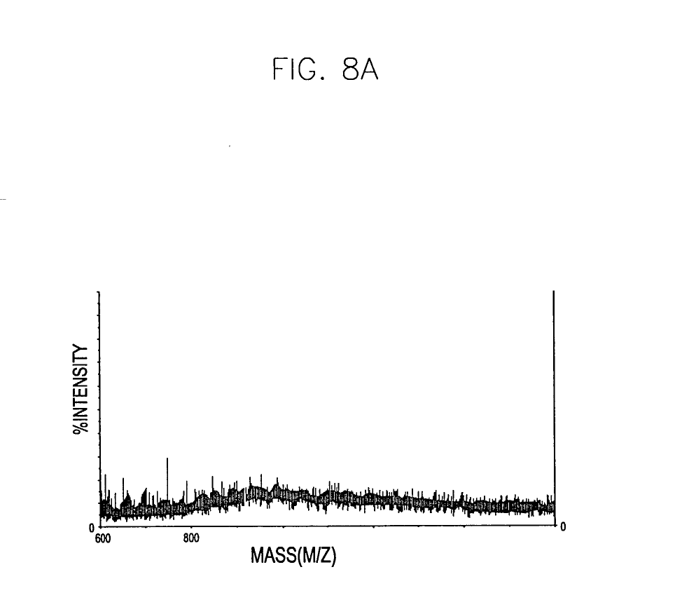

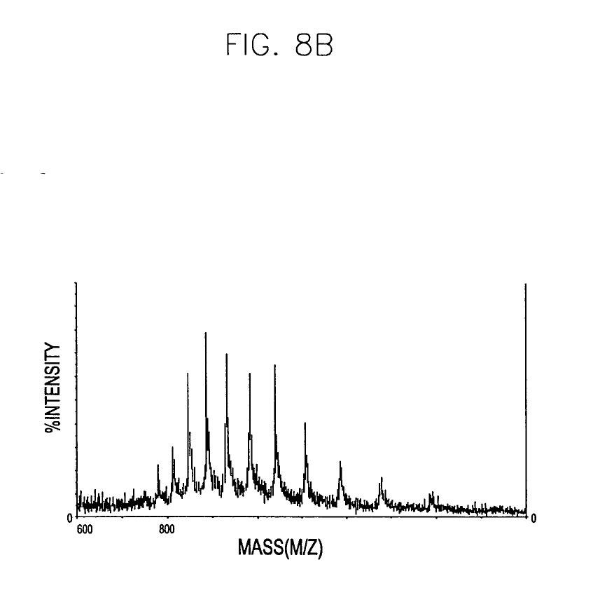

FIGS. 8A and 8B show the mass spectra to illustrate the molecular separation and purification efficiency of a sample clean-up chip connected to a mass spectrometer (ESI-MS) according to the present invention. FIG. 8A shows the mass spectra for myoglobin contained in 500 mM sodium chloride solution but not cleaned-up. Obvious peaks for myoglobin were not obtained due to a small signal-to-noise ratio, similar to the result shown in FIG. 7A. The mass spectra shown in FIG. 8B for myoglobin passed through the sample clean-up chip has greatly improved sensitivity compared to the mass spectra taken before the clean-up.

As is apparent from the experimental examples described above, salts can be easily removed from samples by connecting the sample clean-up chip according to the present invention to the existing ESI-MS. By using the sample clean-up chip according to the present invention, the sample clean-up process for desalting, which is essential in the field of “proteomics” research but takes many hours and human resources, can be easily automated.

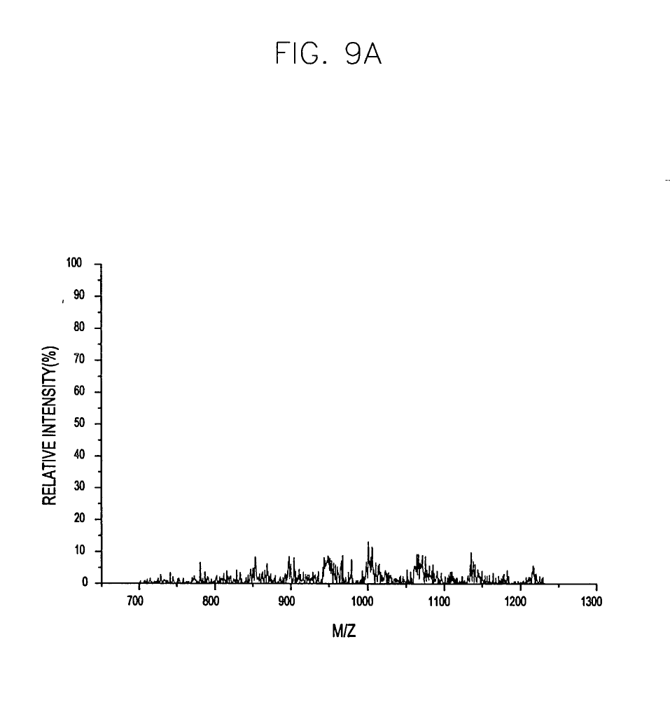

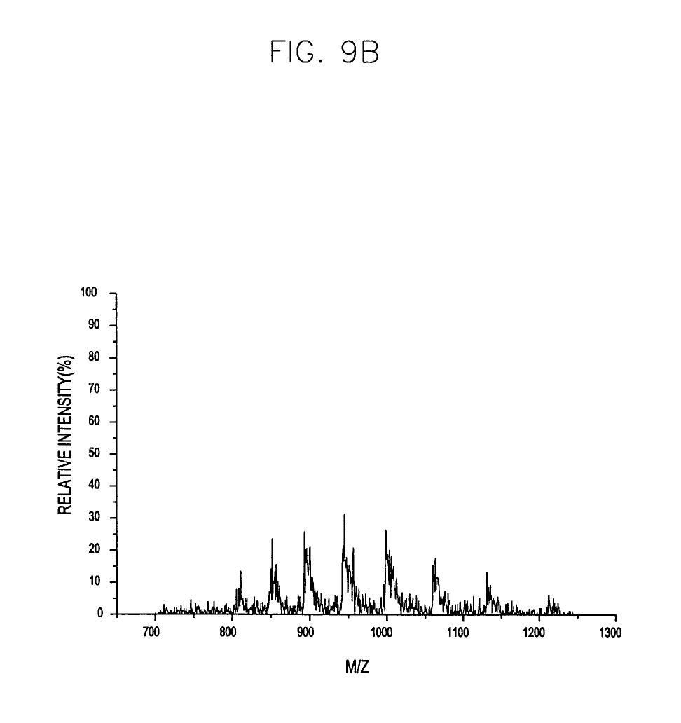

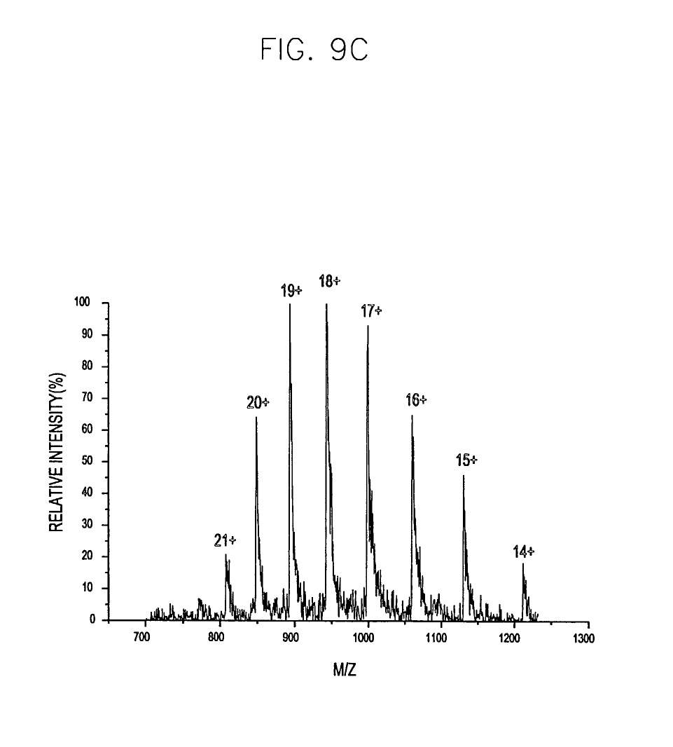

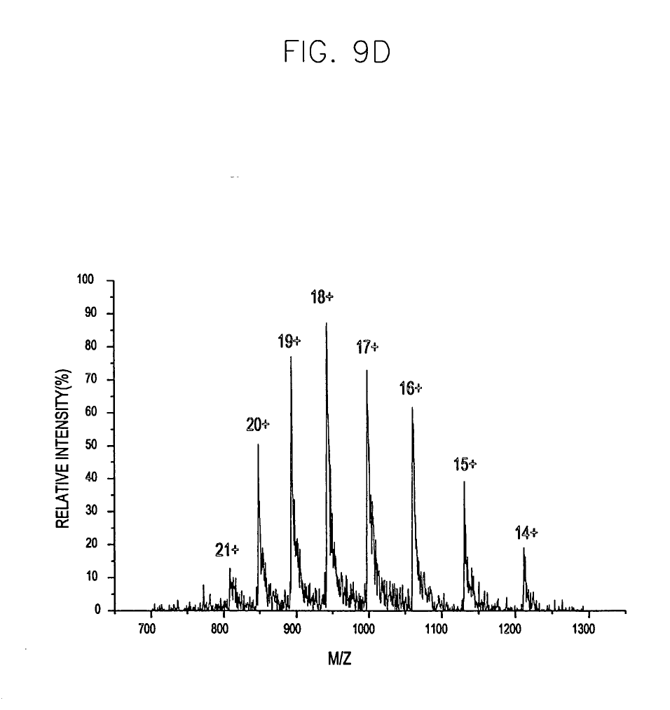

FIGS. 9A through 9D comparatively show the desalting efficiency between a common clean-up method using dialysis membranes and the clean-up method using the sample clean-up chip according to the present invention for samples to be introduced into an ESI-MS.

For comparison of the desalting efficiency, three dialysis membranes (molecular weight cutoff (MWCO) value 1200) were prepared. Myoglobin samples in 100 mM Tris and 10 mM EDTA with the addition of 500 mM NaCl were prepared and dialyzed using the dialysis membranes in a 10 mM ammonium acetate solution with 1% acetic acid for 10 min, 60 min, and 120 min, respectively, while changing the ammonium acetate solution every 1 hour. The myoglobin samples after the clean-up were analyzed using the ESI-MS.

FIG. 9A shows the mass spectra for the sample after a 10-min clean-up in the solution using a dialysis membrane. As is apparent from the sensitivity in the mass spectra of FIG. 9A, salts were hardly removed from the sample. FIGS. 9B and 9C show the mass spectra for the samples after 60-min and 120-min clean-up, respectively, in the solution using dialysis membranes.

FIG. 9D shows the mass spectra for the same sample after clean-up using a sample clean-up chip according to the present invention. It took about 1 second to desalt the protein sample in the sample clean-up chip having a depth of 100 μm. As shown in FIG. 9D, desalting with the sample clean-up chip according to the present invention ensures similar sample detection sensitivity as the method described with reference to FIG. 9C. As is apparent from the comparison of mass spectra above, a generally 2-hour clean-up (desalting) process using a dialysis membrane can be performed mearly within 1 second by means of the sample clean-up chip according to the present invention. A high-speed, high-efficiency sample clean-up is ensured by the present invention.

While this invention has been particularly shown and described with reference to preferred embodiments thereof, it will be understood by those skilled in the art that various changes in form and details may be made therein without departing from the spirit and scope of the invention as defined by the appended claims.

As described above, the sample clean-up apparatus (chip) for mass spectrometry according to the present invention can remove low-molecular weight substances including salts from high-molecular weight biological samples through simple molecular diffusion in laminar flow with high-speed and high-efficiency, without any separation tools such as a separation membrane or an adsorbing material. The clean-up by the sample clean-up apparatus according to the present invention is advantageously simple with high purification efficiency.

The present invention also ensures easy solvent exchange for samples of interest that are to be separated. The present invention can be applied to the field of “proteomics” research being actively performed in recent years for sample clean-up in protein analysis, realizing automation in sample analysis. Practical use of the present invention in diverse research fields as an effective sample separation and purification method will increase research efficiency with reduced time, labor, and expenses.

The sample clean-up apparatus for mass spectrometry according to the present invention is manufactured as a “lab-on-a-chip” based apparatus. When a protein sample is passed through the sample pretreatment chip according to the present invention before mass spectrometry, mass spectra with higher signal to noise ratio can be obtained than non-pretreated samples. In comparing the desalting efficiency of the sample clean-up chip according to the present invention using a dialysis membrane, the desalting clean-up process which took about 2 hours with the dialysis membrane can be achieved within only 1 second with the sample clean-up chip according to the present invention. The present invention ensures high-speed, high-efficiency sample clean-up for mass spectrometry.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A sample clean-up apparatus for mass spectrometry, comprising:
a sample inlet through which a mixture sample of interest to be cleaned-up is introduced, the sample solution containing a mixture of high-molecular weight substances and low-molecular weight substances;
clean-up solution inlets through which a clean-up solution is introduced;
a channel formed in a substrate with branches connected to the sample inlet and the clean-up solution inlets, the channel allowing a flow of laminar streams of the mixture sample and the clean-up solution introduced through the sample inlet and the clean-up solution inlets, respectively;
low-molecular weight substance outlets connected to opposing branches of the respective clean-up solution inlets, for discharging low-molecular weight substances in the mixture; and
a high-molecular weight substance outlet connected to an opposing branch of the sample inlet, for discharging purified high-molecular weight substances in the mixture sample.

2. The sample clean-up apparatus of claim 1, wherein, to form a laminar stream of the mixture sample in the middle of the channel and laminar streams of the clean-up solution around the laminar stream of the mixture sample, the sample inlet and the high-molecular weight substance outlet are aligned to the longitudinal axis of the channel, the clean-up solution inlets are located close to both sides of the sample inlet, and the low-molecular substance outlets are located close to both sides of the high-molecular substance outlet.

3. The sample clean-up apparatus of claim 1 or 2, wherein the channel has a width from 0.01 μm to 30 cm and a height from 0.01 μm to 10 cm.

4. The sample clean-up apparatus of claim 1 or 2, wherein the mixture sample includes substances having a molecular weight difference no less than 100.

5. The sample clean-up apparatus of claim 1 or 2, wherein the mixture sample comprises low-molecular weight substances selected from the group consisting of salts, metal ions, and surfactants and a high-molecular weight substance selected from the group consisting of proteins, peptides, enzymes, deoxyribonucleic acids (DNAs), and oligonucleotides, the low-molecular weight substances discharged through the low-molecular weight outlets comprises salts, metal ions, and surfactants, and the high-molecular weight substances discharged through the high-molecular weight substance outlet comprises proteins, peptides, enzymes, deoxyribonucleic acids (DNAs), and oligonucleotides.

6. The sample clean-up apparatus of claim 1 or 2, wherein the high-molecular weight substance outlet is directly connected to a mass spectrometer for mass analysis of the high-molecular weight substances discharged through the high-molecular weight substance outlet.

7. The sample clean-up apparatus of claim 6, wherein the mixture sample comprises a low-molecular weight substances selected from the group consisting of salts, metal ions, and surfactants and a high-molecular weight substances selected from the group consisting of proteins, peptides, enzymes, deoxyribonucleic acids (DNAs), and oligonucleotides, the low-molecular weight substances discharged through the low-molecular weight outlets comprises salts, metal ions, and surfactants, and the high-molecular weight substances discharged through the high-molecular weight substance outlet comprises proteins, peptides, enzymes, deoxyribonucleic acids (DNAs), and oligonucleotides and is analyzed by the mass spectrometer connected to the high-molecular weight substance outlet.

8. The sample clean-up apparatus of claim 1 or 2, wherein the substrate for the channel fabrication is at least one selected from the group consisting of glass, quartz, fused silica, and plastic.

9. The sample clean-up apparatus of claim 8, wherein the substrate for the channel fabrication is at least one plastic selected from the group consisting of poly(dimethylsiloxane), polymethylmethacrylate, polycarbonate, polyethylene, polypropylene, and polystyrene.

10. The sample clean-up apparatus of claim 8, wherein the channel in the glass, quartz, or fused silica substrate is fabricated by photolithography and chemical etching techniques, molding, coining, mechanical machining, or laser machining technique.

11. The sample clean-up apparatus of claim 9, wherein the channel in the plastic substrate is fabricated by molding, coining, mechanical machining, or laser machining technique.

12. The sample clean-up apparatus of claim 1 or 2, wherein the substrate comprises a first substrate in which the channel is formed and a second substrate covering the channel formed in the first substrate.

13. The sample clean-up apparatus of claim 1 or 2, wherein solvent or buffer exchange of a sample occurs while the laminar streams flow along the channel.

14. The sample clean-up apparatus of claim 1 or 2, wherein the clean-up solution is water or a buffer solution.
